(19) United States
(12) Patent Application Publication
(10) Pub. No.: US 2025/0211017 A1
(43) Pub. Date: Jun. 26, 2025

(54) DC FAST CHARGE BOOSTER CIRCUIT INTEGRATION WITH THE BATTERY CURRENT CONTROL MODULE

(71) Applicant: Ford Global Technologies, LLC, Dearborn, MI (US)

(72) Inventor: Mohamed Elshaer, Canton, MI (US)

(21) Appl. No.: 18/393,909

(22) Filed: Dec. 22, 2023

(51) Int. Cl. H02J 7/04; H02M 1/14; H02M 1/42; H02M 1/44; H02M 3/335

(52) U.S. Cl. CPC H02J 7/04; H02M 1/143; H02M 1/4233; H02M 1/44; H02M 3/33584

(57) ABSTRACT

An automotive power system has a battery current control module including a bidirectional power factor correction circuit, an isolated DC/DC converter, and an active ripple energy storage circuit connected between the bidirectional power factor correction circuit and isolated DC/DC converter. The system further has a DC charge input connected with the isolated DC/DC converter.

### TECHNICAL FIELD

This disclosure relates to automotive power systems.

### BACKGROUND

An automotive vehicle may use electrical energy to power an electric machine. The electric machine may convert this electrical energy to mechanical energy to propel the vehicle. The automotive vehicle may include various power electronics equipment to condition and store electrical energy.

### SUMMARY

An automotive power system has a battery current control module including a bidirectional power factor correction circuit, an isolated DC/DC converter, and an active ripple energy storage circuit connected between the bidirectional power factor correction circuit and isolated DC/DC converter. The isolated DC/DC converter includes a transformer, a switching bridge, and a switch bank connected between the transformer and switching bridge. The system further has a DC charge input connected with the isolated DC/DC converter between the switch bank and switching bridge.

A method includes, responsive to connection of a battery current control module, including a bidirectional power factor correction circuit, an isolated DC/DC converter, and an active ripple energy storage circuit connected between the bidirectional power factor correction circuit and isolated DC/DC converter, the isolated DC/DC converter including a transformer, a switching bridge, and a switch bank connected between the transformer and switching bridge, with an AC source, closing the switch bank and operating switches of the switching bridge within a first frequency range. The method further includes, responsive to connection of a DC charge input, connected with the isolated DC/DC converter between the switch bank and switching bridge, with a DC source, opening the switch bank and operating the switches within a second frequency range less than the first frequency range.

A vehicle has a battery current control module including a bidirectional power factor correction circuit and an isolated DC/DC converter. The isolated DC/DC converter includes a transformer, a switching bridge, and a switch bank connected between the transformer and switching bridge. The vehicle further has an AC charge input, an electromagnetic interference filter connected between the bidirectional power factor correction circuit and AC charge input, a DC charge input connected with the isolated DC/DC converter between the switch bank and switching bridge, and a controller. The controller, during connection of the AC charge input with an AC source, operates switches of the switching bridge within a first frequency range, and during connection of the DC charge input with a DC source, operate the switches within a second frequency range less than the first frequency range.

### BRIEF DESCRIPTION OF THE DRAWINGS

FIG. 1 is a schematic diagram of a system including a booster circuit.

FIG. 2 is a schematic diagram of a system including a battery current control module.

FIGS. 3 through 8 are schematic diagrams of systems including booster circuits integrated with battery current control modules.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Charging a traction battery from 20% to 80% in under 10 minutes is considered acceptable by most EV customers. Such may require charging at 350 KW. However, most 400V DC fast charge stations have an upper maximum power of 150 kW. Increasing power levels beyond 150 KW at 400V may not be practical. For example, charging a 400V battery at 350 KW requires a large cable wire to carry 1000 A. A charging cable with the current handling of 1000 A is estimated to weigh 37 kg. The automotive industry is moving toward 800V battery architectures. Delivering 350 KW to an 800V battery requires a charging cable with 440 A current handling at a weight of 12 kg. A booster module can be added to vehicles to enable them to utilize the 400V and 800V DC fast charge stations.

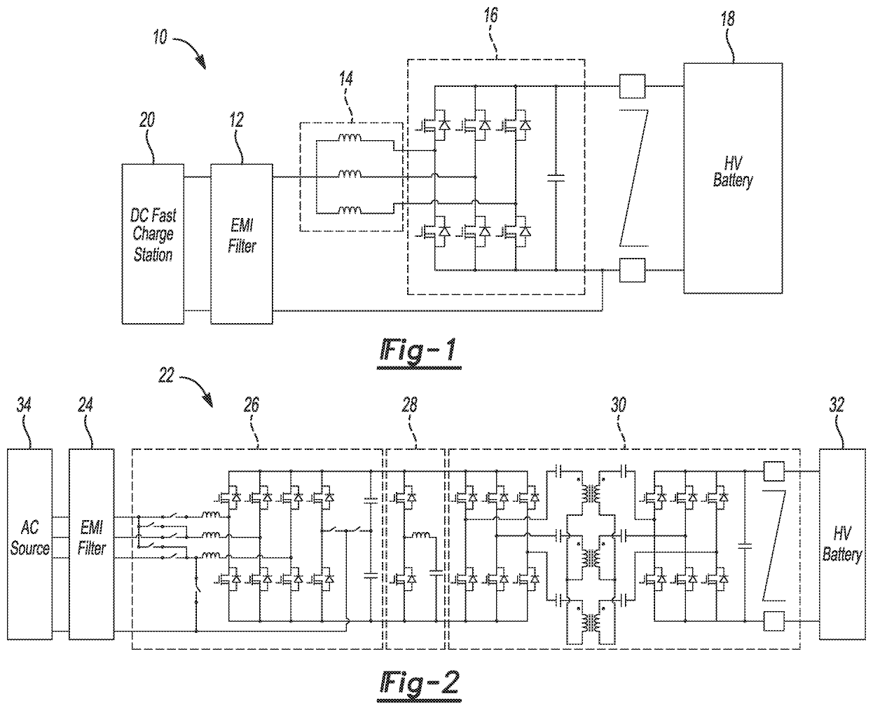

FIG. 1 is a schematic diagram of a three-phase interleaved 400V to 800V booster circuit topology 10. The topology 10 includes an electromagnetic interference filter 12, an inductor bank 14, a switching bridge 16, and a traction battery 18. The inductor bank 14 is connected between the electromagnetic interference filter 12 and switching bridge 16. The switching bridge 16 is connected between the inductor bank 14 and traction battery 18. The topology 10 is connected with a DC fast charge station via the electromagnetic interference filter 12.

Increasing the power density requires further optimization of the high voltage charging architecture. FIG. 2 is a schematic diagram of an onboard charger circuitry topology 22. The topology 22 includes an electromagnetic interference filter 24, a bidirectional power factor correction circuit 26 (e.g., a single/three phase bidirectional totem pole power factor correction circuit), an active ripple energy storage circuit 28, an isolated high voltage DC/DC converter 30, and a traction battery 32. The bidirectional power factor correction circuit 26 is connected between the electromagnetic interference filter 24 and active ripple energy storage circuit 28. The active ripple energy storage circuit 28 is connected between the bidirectional power factor correction circuit 26 and isolated high voltage DC/DC converter 30. The isolated high voltage DC/DC converter 30 is connected between the active ripple energy storage circuit 28 and traction battery 32. The topology 22 is connected with an AC source 34 via the electromagnetic interference filter 24. Power from the AC source 34 may thus charge the traction battery 32.

It is proposed to use a battery current control module (BCCM), such as that illustrated in FIG. 2, to construct portions of a booster module. BCCMs play a role in managing the flow of electric current to and from the battery. BCCMs function as control units that interface between the battery, the charging system, and the electrical loads. They monitor and control various parameters such as battery state of charge, voltage, and temperature, and based on this information, they manage the flow of current to the battery. BCCMs may facilitate charging control by overseeing the charging process of the battery, and managing the voltage and current supplied by the charging system. By monitoring the battery's state of charge and adjusting the charging parameters accordingly, BCCMs attempt to ensure the battery receives the appropriate level of charge to maintain performance. Similarly, BCCMs may be responsible for discharging control. They can manage the current output from the battery to the electrical loads in the vehicle. By controlling the current flow, BCCMs may ensure a controlled supply of power to the various electrical components and systems. BCCMs may also implement various measures for the battery. For instance, they may monitor battery temperature to prevent overheating. They may also detect overvoltage or undervoltage situations and implement measures to preclude short circuits or excessive current draw. BCCMs may feature diagnostic capabilities. These modules can monitor the health and performance of the battery system. They can log codes and provide diagnostic information, facilitating maintenance.

Communication interfaces are often incorporated into BCCMs. These interfaces, such as Controller Area Network (CAN) or LIN (Local Interconnect Network), allow BCCMs to exchange information with other vehicle systems, including the engine control unit or the body control module. This enables coordinated operation and integrated control across various vehicle functions. BCCMs can receive commands or instructions from other control units and adjust current flow accordingly.

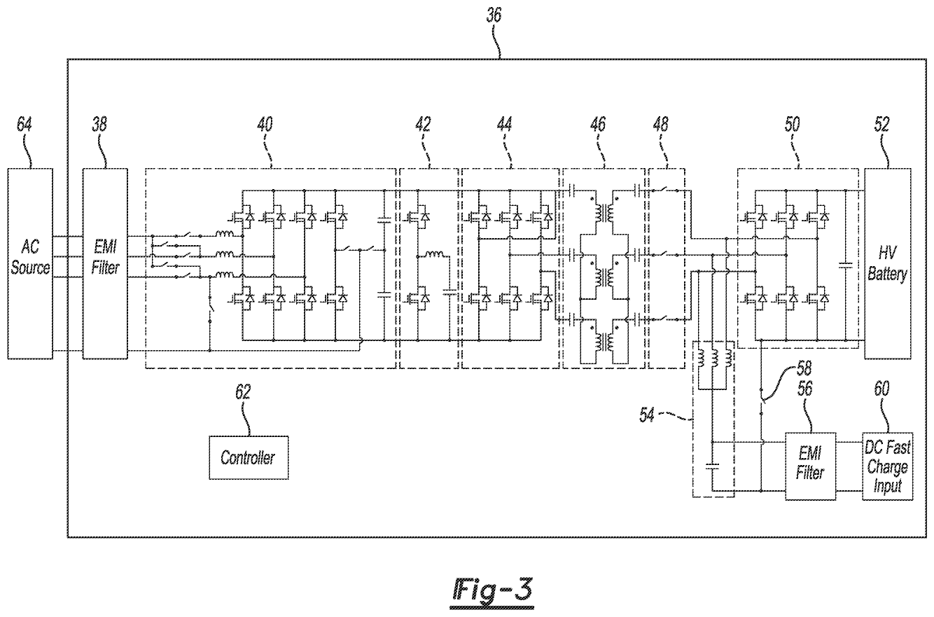

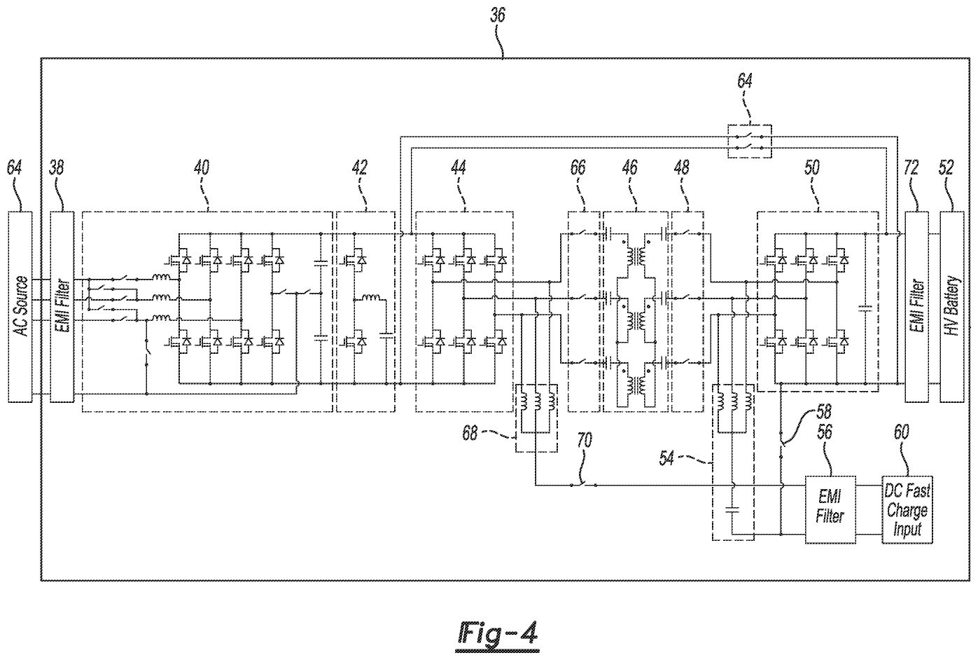

Referring to FIG. 3, a vehicle 36 includes an electromagnetic interference filter 38, a bidirectional power factor correction circuit 40 (e.g., a single/three phase bidirectional totem pole power factor correction circuit), an active ripple energy storage circuit 42, a switching bridge 44, a transformer 46, a switch bank 48, a switching bridge 50, a traction battery 52, an inductor/capacitor bank 54, an electromagnetic interference filter 56, a switch 58, a DC fast charge input 60, and a controller 62. The controller 62 is in communication with/exerts control over the components of FIG. 3. The vehicle 36 is connected with an AC source 64 via the electromagnetic interference filter 38.

The bidirectional power factor correction circuit 40 is connected between the electromagnetic interference filter 38 and active ripple energy storage circuit 42. The active ripple energy storage circuit 42 is connected between the bidirectional power factor correction circuit 40 and switching bridge 44. The switching bridge 44 is connected between the active ripple energy storage circuit 42 and transformer 46. The transformer 46 is connected between the switching bridge 44 and switch bank 48. The switch bank 48 is connected between the transformer 46 and switching bridge 50. The switching bridge 50 is connected between the switch bank 48 and traction battery 52.

The inductor/capacitor bank 54 is connected between the switch bank 48 and electromagnetic interference filter 56. The electromagnetic interference filter 56 is connected between the inductor/capacitor bank 54 and DC fast charge input 60. The switch 58 is connected between the switching bridge 50 and electromagnetic interference filter 56.

Booster circuit integration with the BCCM is thus achieved, configuring the high voltage DC/DC converter's secondary switches to perform the booster function. The switch bank 48, inductor/capacitor bank 54, electromagnetic interference filter 56, and switch 58 (if included) have been added to enable interfacing the DC fast charge input 60. The switch bank 48 is for disconnecting the transformer 46 and secondary resonant capacitor (if included) from the secondary bridge 50. Each of three inductors of the inductor/capacitor bank 54 are connected to one inverter leg. At least one inductor must be interfaced to the inverter leg. Two or three inductors may be added for current sharing purposes. This concept can be generalized to any number of phases. For example, a single-phase CLLC or DAB can have a maximum of two inductors interfaced to each of the two legs. A three-phase CLLC or DAB can have a maximum of three inductors interfaced to each of the three legs. A minimum of one inductor must be connected to a bridge leg, and the maximum number of inductors equals the maximum number of bridge legs. The other terminals of the inductors are tied together and connected to the positive terminal of a capacitor of the inductor/capacitor bank 54. The negative terminal of the capacitor is connected to the secondary bridge HVDC-bus. The electromagnetic interference filter 56 may be added to filter both differential mode current and common mode current generated by the switching mode power supply. The switch 58 (if present) can disconnect the DC fast charge negative bus from the HVDC-.

When the vehicle 36 is connected to the AC grid 64, the switch bank 48 is closed such that the capacitor or the transformer secondary windings are connected to the secondary side bridge 50. During this mode of operation, the DC fast charge input 60 is disconnected from the source and unloaded. Bidirectional power can flow between the AC source 64 and traction battery 52. An LC filter is formed by the inductor(s) and capacitor of the inductor/capacitor bank 54 connected to the secondary side bridge 50. During this mode of operation, voltage is developed across the LC network and a small current is expected to circulate through them.

When the vehicle 36 is disconnected from the AC grid 64 and connected to a DC fast charge station, the switch bank 48 is opened such that the secondary side capacitors and the transformer secondary windings are disconnected from the secondary bridge 50. A single-phase or multi-phase bidirectional boost converter is configured using the BCCM's secondary bridge 50 and the add-on LC network. Bidirectional power can flow between the DC fast charge input 60 and the traction battery 52. The duty cycle of the secondary bridge 50 is modulated to control the amount of power flowing between the DC fast charge station and the traction battery 52.

The secondary bridge 50 is switched at two different frequency ranges depending on the mode of operation. This enables minimizing the current flowing through the added LC network while charging the traction battery 50 from the AC source 64. For example, when connected to the AC source 64, the CLLC circuit and the secondary rectifier operate at a frequency range between 140 kHz to 300 kHz. On the other hand, the secondary side bridge 50 is operated at 20 kHz or less when connected to the DC fast charge station. The added LC filter is optimized in a similar way when designing a bidirectional boost converter operating at a specified frequency (e.g., 20 kHz). The electromagnetic interference filter 56 is designed to filter only the noise produced by the integrated booster.

Referring to 4, the vehicle 36 can further include switch bank 64, switch bank 66, inductor bank 68, switch 70, and electromagnetic interference filter 72. The switch bank 64 enables direct connection of the active ripple energy storage circuit 42 to the electromagnetic interference filter 72. The switch bank 66 is connected between the switching bridge 44 and transformer 46. The inductor bank 68 is connected between the switching bridge 44 and switch 70. The switch 70 is connected between the inductor bank 68 and electromagnetic interference filter 56. The electromagnetic interference filter 72 is connected between the switching bridge 50 and traction battery 52. The circuit thus configures the high voltage DC/DC converter's primary switches to perform the booster function. The topology allows for using both the primary and secondary bridges 44, 50 to construct a 6-phase boost converter. Three inductors of the inductor bank 68 are connected to the primary bridge 44. The switch bank 66 is open while the switch bank 64 is closed when the vehicle 36 is connected to a DC fast charge station.

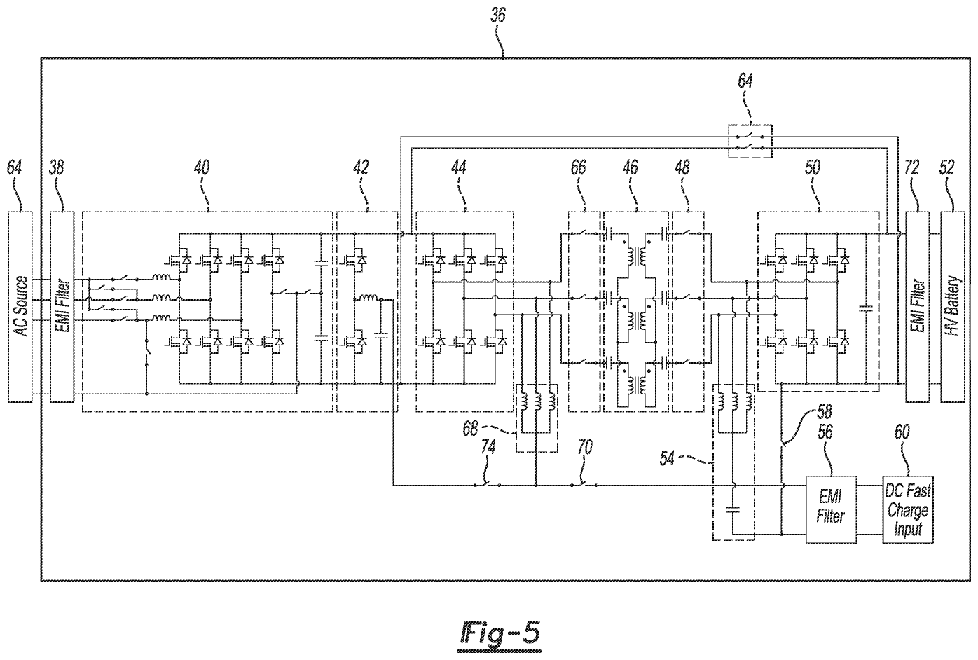

Referring to FIG. 5, the vehicle 36 can further include switch 74 connected between the active ripple energy storage circuit 42 and switch 70. This configures the active ripple energy storage circuit 42 to perform the booster function. That is, the active ripple energy storage circuit 42 can be configured as a boost converter when the vehicle 36 is connected to a DC fast charge station. This is achieved via the switch 74, which is closed during DC fast charge operation and open otherwise.

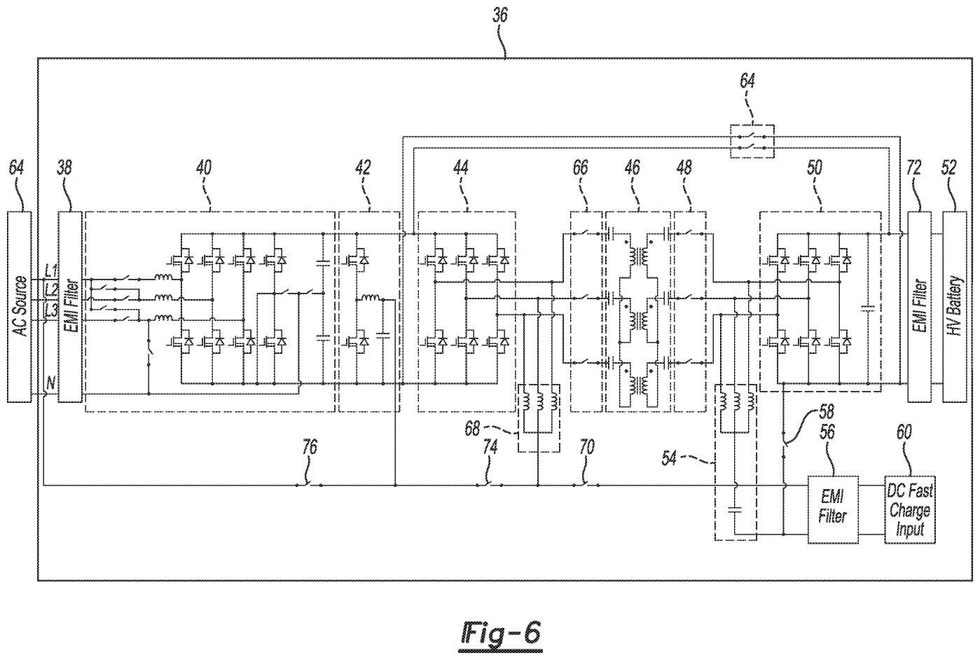

Referring to FIG. 6, the vehicle 36 can further include switch 76 connected between the AC source 64 and switch 74. This configures the bidirectional power factor correction circuit 40 to perform the booster function. That is, the AC/DC power factor correction circuit 40 can act as a multi-phase boost converter when the vehicle 36 is connected to a DC fast charge station. The switch 76 is added to connect the DC fast charge input 60 to L1. The switch box inside the BCCM is configured such that the input of the DC fast charge station appears across L1, L2, and L3, and the return goes through the neutral line.

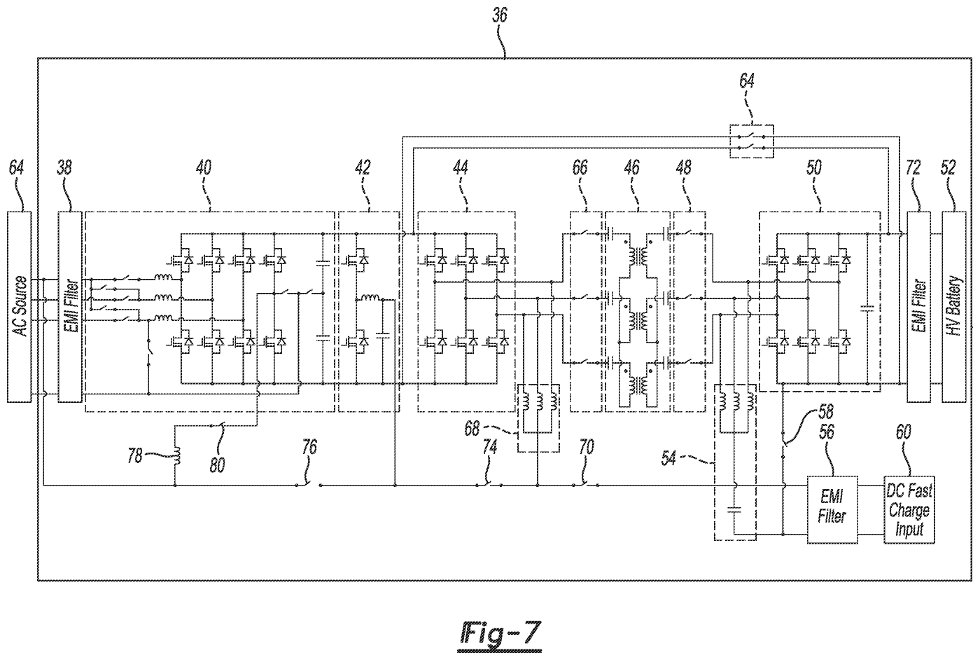

Referring to FIG. 7, the vehicle 36 can further include inductor 78 and switch 80 connected in series. This configures the LF leg to perform the booster function.

These proposed circuits allow for the use of the BCCM's field effect transistors and inductors to form boost converters to enable sharing of the current among the phases. The switch legs are interleaved, so the differential mode current is minimized at the input and output. For instance, when configuring the BCCM circuit to operate as a three-phase boost converter, the pulse width modulation between the bridge legs is phase shifted by 120° (i.e., phase shift=360°/number of phases). These circuits, however, may require either a large energy storage capacitor or active ripple energy storage to ensure the traction battery 52 is charged with DC current.

The electrolytic capacitor bank is considered one of the significant components in the BCCM. It can consume 18% of the overall BCCM package volume. To help increase the BCCM's power density, an active ripple energy storage circuit can be added as described above, which is estimated to reduce the overall electrolytic capacitor bank size by 70%.

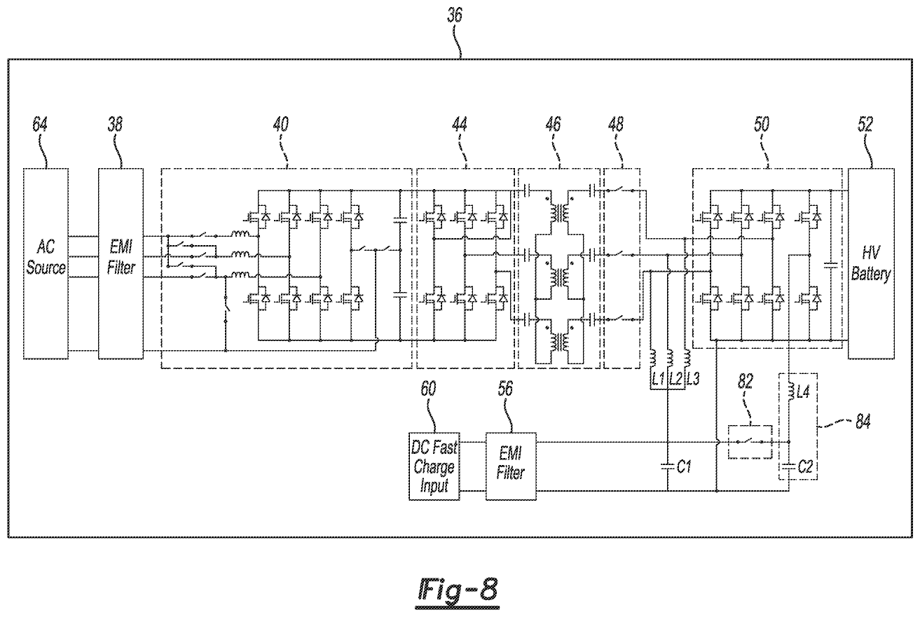

The active ripple energy storage function can be implemented in an integrated BCCM/booster system. Referring to FIG. 8, the vehicle 36 (relative to FIG. 3) can omit the active ripple energy storage circuit 42 and further include switch 82 and circuitry 84 connected between the inductor/capacitor bank 54 and traction battery 52. In this implementation, another leg is added to the secondary side bridge 50. A third leg is added if the bridge 50 has two switching legs. If the secondary bridge 50 has three switching legs, a fourth leg is added, etc. The switch node of the added leg is connected to inductor L4, and the other terminal of the inductor L4 is connected to capacitor C2. The output across the capacitor C2 is referenced to the traction battery's HVDC-bus. The inductor LA and capacitor C2 form an LC filter to attenuate high frequency switching voltage. The voltage across the capacitor C2 is DC or has a low-frequency ripple (˜60-120 Hz). Low-frequency voltage is a voltage that has a much lower frequency than the switching frequency (i.e., high frequency/low frequency>>10). The switch 82 is added to disconnect capacitor C1 from the capacitor C2.

When the charger is connected to the AC grid 64, the switch bank 48 is closed and the switch 82 is opened. Bidirectional power flows between the AC source 64 and traction battery 52. No load is connected across the capacitor C1, and a small current is expected to circulate through L1, L2, L3, and the capacitor C1 since these elements are part of the high voltage DC/DC converter. The added leg to the secondary side bridge 50 is switched to perform the active ripple energy storage function. Switching frequency of the added leg may differ from the switching frequency of the high voltage DC/DC converter (the primary bridge 44, transformer 44 with series connected capacitors, and secondary bridge 50 consisting of the original three legs). The added leg L4 and capacitor C2 form a bi-directional buck/boost converter or an active ripple energy storage circuit. The active ripple energy storage circuit formed on the high voltage DC bus is controlled to store energy and discharge energy in the capacitor C2. The capacitor C2 is expected to see a ripple voltage proportional to the power delivered to the traction battery 52. The active ripple energy storage circuit's current is controlled to minimize the ripple current delivered to the traction battery 52, and to generate an AC current that is proportional and synchronized with the AC line voltage.

When the vehicle 36 is connected to a DC fast charge station, the switch bank 48 is opened, and the switch 58 is closed. By opening the switch bank 48, the transformer 46 and its series-connected capacitors are disconnected from the secondary side bridge 50. By closing the switch 58, the capacitor C1 is connected in parallel with the capacitor C2. A multi-phase booster circuit can be implemented. The added switching leg and its LC filter (the inductor L4 and capacitor C2) form another phase for the booster circuit. Hence, the power delivered from the DC fast charge input 60 to the traction battery 52 can be split among all phases. A current sensor can be added to measure the current flowing through each phase leg. The power flowing through each leg is controlled independently. For example, the added leg can be controlled to deliver power lower than the power delivered by the other three legs.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims.

The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An automotive power system comprising:
a battery current control module including a bidirectional power factor correction circuit, an isolated DC/DC converter, and an active ripple energy storage circuit connected between the bidirectional power factor correction circuit and isolated DC/DC converter, the isolated DC/DC converter including a transformer, a switching bridge, and a switch bank connected between the transformer and switching bridge; and
a DC charge input connected with the isolated DC/DC converter between the switch bank and switching bridge.

2. The automotive power system of claim 1 further comprising a controller programmed to close the switch bank responsive to connection of the battery current control module with an AC source.

3. The automotive power system of claim 2, wherein the controller is further programmed to open the switch bank responsive to connection of the DC charge input to a DC source.

4. The automotive power system of claim 3, wherein the controller is further programmed to operate switches of the switching bridge within a first frequency range during the connection of the battery current control module with an AC source, and within a second frequency range less than the first frequency range during the connection of the DC charge input to an DC source.

5. The automotive power system of claim 3, wherein the isolated DC/DC converter further includes a second switching bridge, a second switch bank connected between the transformer and second switching bridge, and a third switch bank connected with opposite sides of the isolated DC/DC converter, wherein the DC charge input is further connectable with the isolated DC/DC converter between the second switching bridge and second switch bank via a switch and wherein the controller is further programmed to open the second switch bank and close the third switch bank responsive to the connection of the DC charge input to a DC source.

6. The automotive power system of claim 5, wherein the DC charge input is further directly connectable with the active ripple energy storage circuit via the switch and a second switch and wherein the controller is further programmed to close the second switch responsive to the connection of the DC charge input to a DC source.

7. The automotive power system of claim 6, wherein the DC charge input is further directly connectable with an AC charge input via the switch, second switch, and a third switch, and directly connectable with the bidirectional power factor correction circuit via the switch, second switch, third switch, and a fourth switch.

8. A method comprising:
responsive to connection of a battery current control module, including a bidirectional power factor correction circuit, an isolated DC/DC converter, and an active ripple energy storage circuit connected between the bidirectional power factor correction circuit and isolated DC/DC converter, the isolated DC/DC converter including a transformer, a switching bridge, and a switch bank connected between the transformer and switching bridge, with an AC source, closing the switch bank and operating switches of the switching bridge within a first frequency range; and
responsive to connection of a DC charge input, connected with the isolated DC/DC converter between the switch bank and switching bridge, with a DC source, opening the switch bank and operating the switches within a second frequency range less than the first frequency range.

9. The method of claim 8, wherein the isolated DC/DC converter further includes a second switching bridge, a second switch bank connected between the transformer and second switching bridge, and a third switch bank connected with opposite sides of the isolated DC/DC converter and wherein the DC charge input is further connectable with the isolated DC/DC converter between the second switching bridge and second switch bank via a switch, further comprising, responsive to the connection of the DC charge input with a DC source, opening the second switch bank and closing the third switch bank.

10. The method of claim 9 further comprising, responsive to the connection of the DC charge input with a DC source, closing the switch and a second switch to directly connect the DC charge input with the active ripple energy storage circuit.

11. A vehicle comprising:
a battery current control module including a bidirectional power factor correction circuit and an isolated DC/DC converter, the isolated DC/DC converter including a transformer, a switching bridge, and a switch bank connected between the transformer and switching bridge;
an AC charge input;
an electromagnetic interference filter connected between the bidirectional power factor correction circuit and AC charge input;
a DC charge input connected with the isolated DC/DC converter between the switch bank and switching bridge; and
a controller programmed to, during connection of the AC charge input with an AC source, operate switches of the switching bridge within a first frequency range, and during connection of the DC charge input with a DC source, operate the switches within a second frequency range less than the first frequency range.

12. The vehicle of claim 11, wherein the controller is further programmed to, during the connection of the AC charge input with an AC source, close the switch bank.

13. The vehicle of claim 12, wherein the controller is further programmed to, during the connection of the DC charge input with a DC source, open the switch bank.

14. The vehicle of claim 11, wherein the isolated DC/DC converter further includes a second switching bridge, a second switch bank connected between the transformer and second switching bridge, and a third switch bank connected with opposite sides of the isolated DC/DC converter, wherein the DC charge input is further connectable with the isolated DC/DC converter between the second switching bridge and second switch bank via a switch, and wherein the controller is further programmed to open the second switch bank and close the third switch bank responsive to the connection of the DC charge input to a DC source.

15. The vehicle of claim 14, wherein the DC charge input is further directly connectable with an active ripple energy storage circuit via the switch and a second switch and wherein the controller is further programmed to close the second switch responsive to the connection of the DC charge input to a DC source.

16. The vehicle of claim 15, wherein the DC charge input is further directly connectable with an AC charge input via the switch, second switch, and a third switch, and directly connectable with the bidirectional power factor correction circuit via the switch, second switch, third switch, and a fourth switch.

17. The vehicle of claim 11, wherein the bidirectional power factor correction circuit is a bidirectional totem pole power factor correction circuit.
